(19) United States
(12) Patent Application Publication
(10) Pub. No.: US 2006/0264250 A1
(43) Pub. Date: Nov. 23, 2006

(54) REMOTE CONTROL SYSTEM WITH A WIRELESS EARPHONE FUNCTION AND CORRESPONDING METHOD

(76) Inventors: Xiao-Guang Li, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,475

(22) Filed: Mar. 29, 2006

(30) Foreign Application Priority Data
May 20, 2005 (CN) 200510034749.9

(51) Int. Cl. H04M 1/00

(52) U.S. Cl. 455/575.2

(57) ABSTRACT

A remote control method with a wireless earphone function, the method providing a host for playing video signals and audio signals and a remote control, the host including an audio playing unit, the method includes the steps of: receiving a connectivity signal from an audio signal outlet thereof, and determining whether the connectivity signal indicates that an earphone is connected with the audio signal outlet; transmitting an instruction for switching on a switch of the host to the host if the signal indicates that an earphone is connected with the audio signal outlet; switching on the switch according to the instruction; transmitting audio signals to the remote control; receiving the audio signals; and outputting the audio signals to the earphone via the audio signal outlet. A related system is also provided.

### TECHNICAL FIELD

The present invention relates generally to remote control systems and methods, and particularly to a remote control system with a wireless earphone function and a related remote control method.

### DESCRIPTION OF RELATED ART

Many people have had the unpleasant experience of being disturbed in the night by the sound of a stereo or television being used by someone else. Instead of turning down or turning off the volume, an individual may use an earphone to enjoy their audio or viewing experience so as not to disturb others.

A conventional earphone includes a headset, and a connecting cable having a predetermined length electrically connecting the headset with a device such as a television or a stereo. However, the conventional earphone has several drawbacks. When the earphone is electrically connected to a television or stereo, the movement of the user is limited to the length of the connecting cable. In addition, the user may be at risk of tripping over the connecting cable. Furthermore, since the user is limited by the length of the connecting cable, he or she must sit nearer the television, which may impair his/her eyesight over time.

In order to solve the above-mentioned problems, a wireless earphone is needed so that the user is able to enjoy listening to their television, stereo, or other device wirelessly without disturbing others and while still enjoying freedom of movement as well. However, a wireless earphone may be subject to interference during movement of the user, which may affect the sound quality. Conventionally, to compensate for audio signal loss during wireless transmission, an expensive high-end circuit configuration must be employed.

Accordingly, what is needed is a remote control system with a wireless earphone function and a related method which can overcome the above-described problems and provide convenience for users.

### SUMMARY

A remote control system with a wireless earphone function according to a preferred embodiment of the present invention includes a host and a remote control for controlling the host. The host includes a first Microprogrammable Control Unit (MCU), a first audio signal output module for outputting audio signals, an audio playing unit for playing sounds, a second audio signal output module for outputting audio signals, a first switch connected between the first MCU and the first audio signal output module for controlling the first audio signal output module, and a second switch connected between the first MCU and the second audio signal output module for controlling the second audio signal output module, an audio signal transmitter for transmitting the audio signals to the remote control. The remote control includes an earphone audio unit, a second MCU, and a transmitter. The earphone audio unit includes a receiver for receiving the audio signals from the host, an audio signal outlet for connecting with an earphone, and an earphone detection module for detecting whether an earphone is connected with the audio signal outlet. The second MCU is for generating an instruction for switching on the second switch if the earphone detection module detects that the earphone is connected with the audio signal outlet. The transmitter is for transmitting a first signal corresponding to the instruction for switching on the second switch to the host. When the host receives the first signal, the host switches on the second switch.

A remote control method with a wireless earphone function according to another preferred embodiment of the present invention is also provided. The method utilizes a host for playing video signals and audio signals, and a remote control for controlling the host. The host includes an audio playing unit. The method includes the steps of: (a) the remote control receiving a connectivity signal from an audio signal outlet thereof, and determining whether the connectivity signal indicates that an earphone is connected with the audio signal outlet; (b) the remote control transmitting an instruction for switching on a switch of the host to the host if the signal indicates that an earphone is connected with the audio signal outlet; (c) the host switching on the switch according to the instruction; (d) the host transmitting audio signals to the remote control; (e) the remote control receiving the audio signals; and (f) the remote control outputting the audio signals to the earphone via the audio signal outlet.

Because a hand held remote control is a common piece of equipment for wirelessly controlling many electronic devices, the above-described system and method provide convenient means for a user to take advantage of the availability of an earphone if desired.

Other advantages and novel features will be drawn from the following detailed description of the preferred embodiments with reference to the attached drawings, in which:

### BRIEF DESCRIPTION OF DRAWINGS

FIG. 1 is a block diagram of hardware infrastructure of a host of a remote control system with a wireless earphone function in accordance with a preferred embodiment of the present invention;

FIG. 2 is a block diagram of hardware infrastructure of a remote control of the remote control system in accordance with the preferred embodiment;

FIG. 3 is a flowchart of a preferred method of remote control performed by utilizing the remote control system in accordance with the preferred embodiment;

FIG. 4 is flowchart of implementing one step of the method of FIG. 3, namely turning off audio signals to an audio playing unit of the host, and outputting audio signals via an audio signal transmitter to the remote control;

FIG. 5 is a flowchart of implementing another step of the method of FIG. 3, namely outputting audio signals via the audio playing unit of the host; and

FIG. 6 is a flowchart of controlling a first switch of the host, in order to implement the method of FIG. 3.

### DETAILED DESCRIPTION OF THE PREFERRED EMBODIMENTS

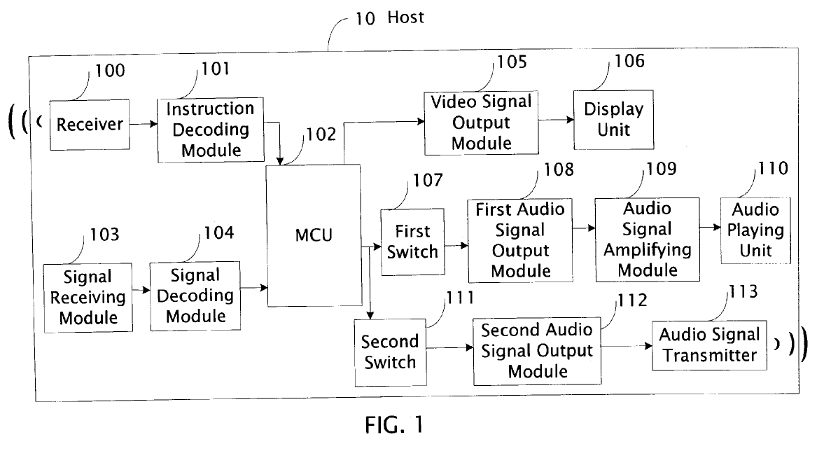

A remote control system with a wireless earphone function and method according to preferred embodiments of the present invention will be described with reference to FIGS. 1 to 6. In the preferred embodiment, the remote control system with a wireless earphone function (hereafter, “the system”) includes a host 10 and a remote control 20.

FIG. 1 is a block diagram of hardware infrastructure of the host 10 of the system. The host 10 includes a receiver 100, an instruction decoding module 101, a Microprogrammable Control Unit (MCU) 102, a television (TV) signal playing unit, a signal receiving module 103, and a signal decoding module 104. The TV signal playing unit includes a video display unit, a loudspeaker audio playing unit, and an audio signal transmitting unit. The video display unit includes a video signal output module 105 and a display unit 106. The loudspeaker audio playing unit includes a first switch 107, a first audio signal output module 108, an audio signal amplifying module 109, and an audio playing unit 110. The audio signal transmitting unit includes a second switch 111, a second audio signal output module 112, and an audio signal transmitter 113. The first switch 107 is connected between the MCU 102 and the first audio output module 108, and is for controlling the loudspeaker audio playing unit. The second switch 111 is connected between the MCU 102 and the second audio signal output module 112, and is for controlling the audio signal transmitting unit. In the preferred embodiment, in an initial status the first switch 107 is switched on, and the loudspeaker audio playing unit is enabled. When the first switch 107 is switched off, the loudspeaker audio playing unit is disabled. In the initial status the second switch 111 is switched off, and the audio signal transmitting unit is disabled. When the second switch 111 is switched on, the audio signal transmitting unit is enabled and transmits audio signals to the remote control 20.

The receiver 100 receives infrared signals from the remote control 20, and transmits the infrared signals to the instruction decoding module 101. The instruction decoding module 101 decodes the infrared signals into a corresponding instruction. Such instruction can be for switching the first or second switches 107, 111 on or off, or adjusting a volume of the audio signal. The signal receiving module 103 is for receiving TV signals, and transmitting the TV signals to the signal decoding module 104. The signal decoding module 104 decodes the TV signals into video signals and audio signals. The video signal output module 105 outputs the video signals, thereby displaying pictures on the display unit 106. Simultaneously, the first audio signal output module 108 outputs the audio signals corresponding to the video signals to the audio playing unit 110, or the second audio signal output module 112 outputs the audio signals corresponding to the video signals to the audio signal transmitter 113, according to the decoded instruction provided by the instruction decoding module 101. For example, when the decoded instruction is for switching on the second switch 111, that means the earphone is plugged into the audio signal outlet 104, and the second audio signal output module 112 outputs the audio signals to the remote control 20 through the audio signal transmitter 113. When the decoded instruction is for switching off the second switch 111, that means the earphone is not plugged into the audio signal outlet 104, and the first audio signal output module 108 outputs the adjusted audio signals to the audio playing unit 110 through the audio signal amplifying module 109.

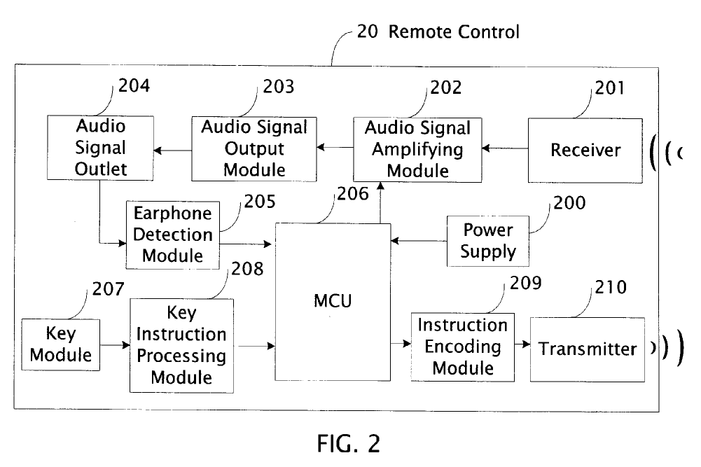

FIG. 2 is a block diagram of hardware infrastructure of the remote control 20 of the system. In the preferred embodiment, the remote control 20 includes an earphone audio unit, a power supply 200, a Microprogrammable Control Unit (MCU) 206, and a remote control unit. The earphone audio unit includes a receiver 201, an audio signal amplifying module 202, an audio signal output module 203, an audio signal outlet 204, and an earphone detection module 205. The remote control unit includes a key module 207, a key instruction processing module 208, an instruction encoding module 209, and a transmitter 210. The receiver 201 receives an audio signal from the host 10, and transmits the audio signal to the audio signal amplifying module 202. The audio signal amplifying module 202 adjusts the audio signal, and outputs the adjusted audio signal to the audio signal outlet 204 through the audio signal output module 203. An earphone (not shown) can be plugged into an earphone jack of the audio signal outlet 204, so that the audio signal outlet 204 transmits the audio signals to the earphone for playing of the corresponding sounds. The earphone detection module 205 is provided for detecting connectivity signals from the earphone jack. For example, if the earphone detection module 205 detects that the earphone is plugged into the audio signal outlet 204, the earphone detection module 205 transmits an in use signal to the MCU 206. The MCU 206 then transmits an instruction to the instruction encoding module 209 for switching on the second switch 111 of the host 10, and the instruction encoding module 209 encodes the instruction into an infrared signal. If the earphone detection module 205 detects that the earphone is not plugged into the audio signal outlet 204, the earphone detection module 205 transmits a not in use signal to the MCU 206. The MCU 206 then transmits an instruction to the instruction encoding module 209 for switching off the second switch 111 of the host 10, and the instruction encoding module 109 encodes the instruction into an infrared signal. The transmitter 210 receives the relevant infrared signal from the instruction encoding module 209, and then transmits the infrared signal to the host 10.

The key module 207 is used for providing a plurality of control keys for user operations, and further includes a key for controlling the first switch 107. The key instruction processing module 208 generates a control instruction according to the operation of the control keys by the user, and transmits the control instruction to the instruction encoding module 209 or the audio signal amplifying module 202 via the MCU 206. That is, the MCU 206 determines the destination of the control instruction according to an in use signal or a not in use signal that the MCU 206 receives from the earphone detection module 205.

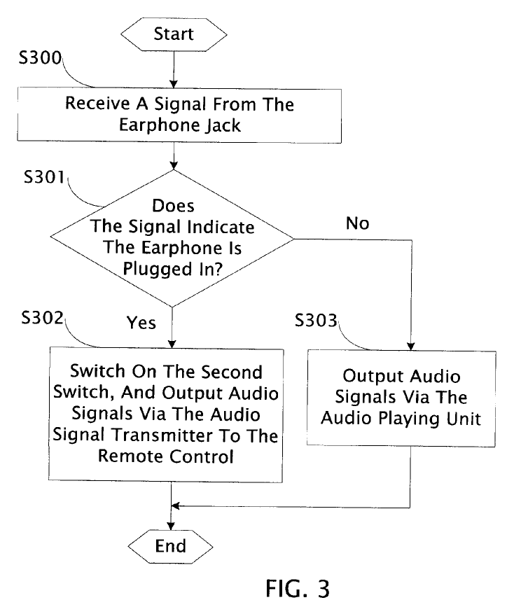

FIG. 3 is a flowchart of a preferred method of remote control performed by utilizing the system. In the preferred embodiment, as described above, in an initial status the first switch 107 is switched on and the second switch 111 is switched off. In step S300, the remote control 20 receives a signal from the earphone jack. In step S301, the remote control 20 determines whether the signal indicates that the earphone is plugged in. If the earphone is plugged in, then in step S302, the host 10 switches on the second switch 111, and outputs audio signals via the audio signal transmitter 113 to the remote control 20. The audio signals are derived from TV signals received by the signal receiving module 103, as described above. If the earphone is not plugged in, then in step S303, the host 10 outputs the audio signals via the audio playing unit 110.

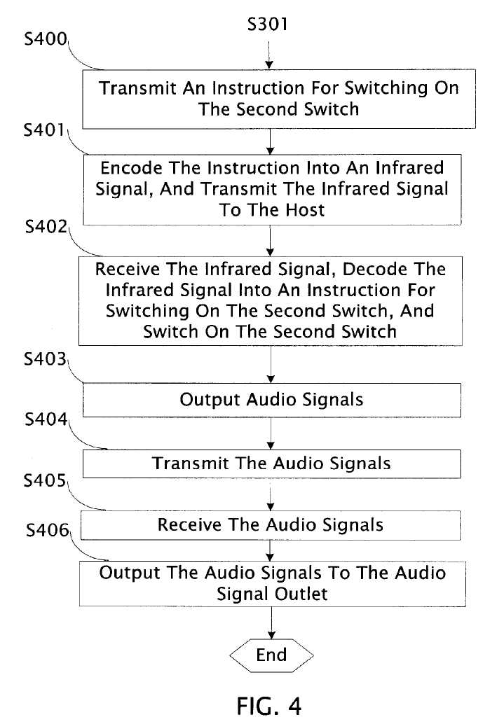

FIG. 4 is a flowchart of implementing step S302 of FIG. 3, namely switching on the second switch 111, and outputting audio signals via the audio signal transmitter 113 to the remote control 20. In step S400, when the signal from the earphone jack indicates that the earphone is plugged into the audio signal outlet 204, the MCU 206 transmits an instruction for switching on the second switch 111 to the host 20. In step S401, the instruction encoding module 209 encodes the instruction into an infrared signal, and transmits the infrared signal to the receiver 100 via the transmitter 210. In step S402, the instruction decoding module 101 receives the infrared signal from the receiver 100, decodes the infrared signal into an instruction for switching on the second switch 111, and transmits the instruction to the MCU 102. The MCU 102 then switches on the second switch 111. In step S403, the second audio signal output module 112 outputs the audio signals to the audio signal transmitter 113. In step S404, the audio signal transmitter 113 transmits the audio signals to the remote control 20. In step S405, the receiver 201 receives the audio signals. In step S406, the audio signal output module 203 outputs the audio signals to the audio signal outlet 204.

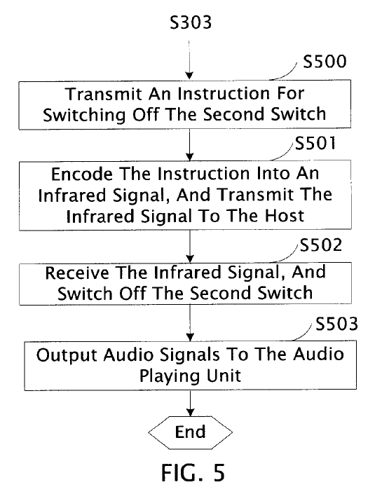

FIG. 5 is a flowchart of implementing step S303 of FIG. 3, namely outputting audio signals via the audio playing unit 209. In step S500, the MCU 206 transmits an instruction for switching off the second switch 111 of the host 20. In step S501, the instruction encoding module 209 encodes the instruction into an infrared signal, and the transmitter 210 transmits the infrared signal to the receiver 100. In step S502, the instruction decoding module 101 receives the infrared signal from the receiver 100, decodes the infrared signal into an instruction for switching off the second switch 111, and transmits the instruction to the MCU 102. The MCU 102 then switches off the second switch 111. In step S503, the first audio signal output module 108 outputs the audio signals to the audio playing unit 110.

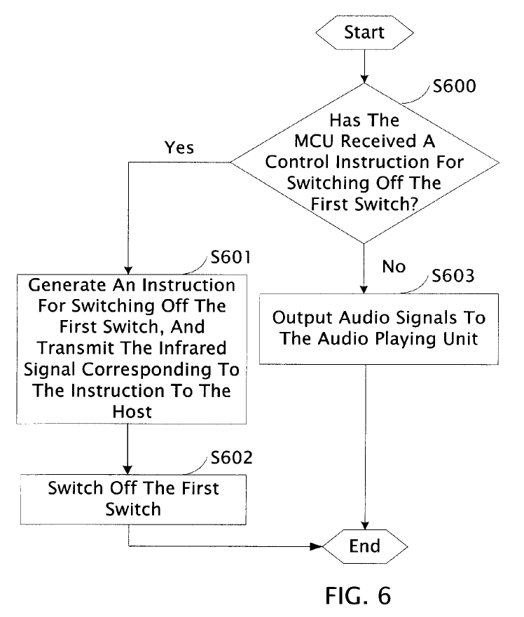

FIG. 6 is a flowchart of controlling the first switch 107 of the host 10 in order to implement the above-described preferred method of remote control. In step S600, the MCU 206 checks whether it has received a control instruction for switching off the first switch 107 from the key instruction processing module 208. That is, if the key module 207 receives a user operation for switching off the first switch 107, then the key instruction processing module 208 generates a corresponding control instruction, and transmits the control instruction to the MCU 206. If the MCU 206 has received a control instruction for switching off the first switch 107, in step S601, the transmitter 210 transmits the infrared signal corresponding to the instruction to the host 10. Then in step S602, the MCU 102 switches off the first switch 107. That is, the audio signal is only output by the second audio signal output module 112 when the second switch 111 is switched on. If the MCU 206 has not received a control instruction for switching off the first switch 107, in step S603, the first audio signal output module 108 outputs the audio signal to the audio playing unit 110.

Because a hand held remote control is a common piece of equipment for wirelessly controlling many electronic devices, the above-described system and method provide convenient means for a user to take advantage of the availability of an earphone if desired.

Although the present invention has been specifically described on the basis of preferred embodiments including preferred methods, the invention is not to be construed as being limited thereto. Various changes or modifications may be made to the embodiments including the methods without departing from the scope and spirit of the invention.

What is claimed is:

1. A remote control system with a wireless earphone function, the system comprising a host and a remote control, the host comprising an a first Microprogrammable Control Unit (MCU), a first audio signal output module, and an audio playing unit for playing sounds, wherein:
the host further comprises:
a second audio signal output module for outputting audio signals;
an audio signal transmitter for transmitting the audio signals to the remote control; and
a first switch connected between the first MCU and the first audio signal output module for controlling the first audio signal output module, and a second switch connected between the first MCU and the second audio signal output module for controlling the second audio signal output module; and
the remote control comprises:
an earphone audio unit comprising a receiver for receiving the audio signals from the host, an audio signal outlet for connecting with an earphone, and an earphone detection module for detecting whether an earphone is connected with the audio signal outlet;
a second MCU for generating an instruction for switching on the second switch if the earphone detection module detects that the earphone is connected with the audio signal outlet; and
a transmitter for transmitting a first signal corresponding to the instruction for switching on the second switch to the host; and
when the host receives the first signal, the host switches on the second switch.

2. The system described in claim 1, wherein the first MCU generates an instruction for switching off the second switch if the earphone detection module detects that the earphone is not connected with the audio signal outlet, the remote control transmits a signal corresponding to the instruction to the host, and the host receives the signal and switches off the second switch according to the signal.

3. The system described in claim 1, wherein the remote control further comprises a key module including a plurality of control keys for user operations, the control keys including a key for controlling the first switch.

4. A remote control method with a wireless earphone function, the method utilizing a host for playing video signals and audio signals and a remote control, the host comprising an audio playing unit, the method comprising the steps of:
the remote control receiving a connectivity signal from an audio signal outlet thereof, and determining whether the connectivity signal indicates that an earphone is connected with the audio signal outlet;
the remote control transmitting an instruction for switching on a switch of the host to the host if the signal indicates that an earphone is connected with the audio signal outlet;
the host switching on the switch according to the instruction;
the host transmitting audio signals to the remote control;
the remote control receiving the audio signals; and
the remote control outputting the audio signals to the earphone via the audio signal outlet.

5. The method described in claim 4, further comprising the steps of:
the remote control generating an instruction for switching off the switch if the connectivity signal indicates that the earphone is not connected with the audio signal outlet;
the remote control transmitting the instruction to the host; and
the host switching off the switch according to the instruction.

6. The method described in claim 5, wherein the host further outputs the audio signals to the audio playing unit.

7. The method described in claim 4, further comprising the steps of:
the remote control generating an instruction for switching off another switch of the host when the remote control receives an operation for controlling the other switch in an initial status;
the remote control transmitting the instruction to the host; and
the host switching off the other switch according to the instruction.

8. The method described in claim 7, further comprising the steps of:
the remote control generating an instruction for switching on the other switch when the remote control receives an operation for controlling the other switch again;
the remote control transmitting the instruction to the host; and
the host switching on the other switch according to the instruction.

9. A remote control system with a wireless earphone function, the system comprising a host and a remote control, the host comprising an audio playing unit, wherein:
the host further comprises:
an audio signal transmitting unit for transmitting audio signals to the remote control;
a first switch connected with the audio signal playing unit for controlling the audio signal playing unit; and
a second switch connected with the audio signal transmitting unit for controlling the audio signal transmitting unit; and
the remote control comprises:
an earphone audio unit comprising a receiver for receiving the audio signals from the host; and
an audio signal outlet for connecting with an earphone for outputting the audio signals; and
when the earphone is connected with the audio signal outlet, the remote control generates an instruction for switching on the second switch, and transmits a signal corresponding to the instruction to the host; and
when the host receives the signal, the host switches on the second switch according to the signal.

10. The system described in claim 9, wherein when the earphone is not connected with the audio signal outlet, the remote control generates an instruction for switching off the second switch, and transmits a signal corresponding to the instruction to the host, and the host receives the signal and switches off the second switch according to the signal.

11. The system described in claim 9, wherein the remote control further comprising a key module including a plurality of control keys for user operations, the control keys including a key for controlling the first switch.
